(19) United States
(12) Patent Application Publication
(10) Pub. No.: US 2014/0134899 A1
(43) Pub. Date: May 15, 2014

(54) PIN FOR A SEMICONDUCTOR CHIP TEST, AND SOCKET FOR A SEMICONDUCTOR CHIP TEST INCLUDING SAME

(71) Applicant: Gyeong-Hwa Na, Seoul (KR)

(72) Inventor: Gyeong-Hwa Na, Seoul (KR)

(21) Appl. No.: 14/125,585

(22) PCT Filed: Jun. 13, 2012
(86) PCT No.: PCT/KR2012/004638

§ 371 Date: Jan. 27, 2014

(30) Foreign Application Priority Data
Jun. 13, 2011 (KR) 20-2011-0005208

(51) Int. Cl. H01R 13/02

(52) U.S. Cl. CPC H01R 13/02
USPC 439/884

(57) ABSTRACT

This patent is about “A New Test Socket Pin & Socket Design for Semiconductor Chip Test”. According to the present invention, there is huge improvement on pin movement with different types of shape and materials. It makes better and stable contact between chip and PCB pad thanks to pivot shaft and rectangle elastomers. So it finally improves reliability of testing. In addition, there is cost reduction effect as we use the pin twice. Once the first contact terminal(Left side of pin) is worn out, the pin can be rotated to its other contact terminal(Right side) and reuse the opposite terminal.

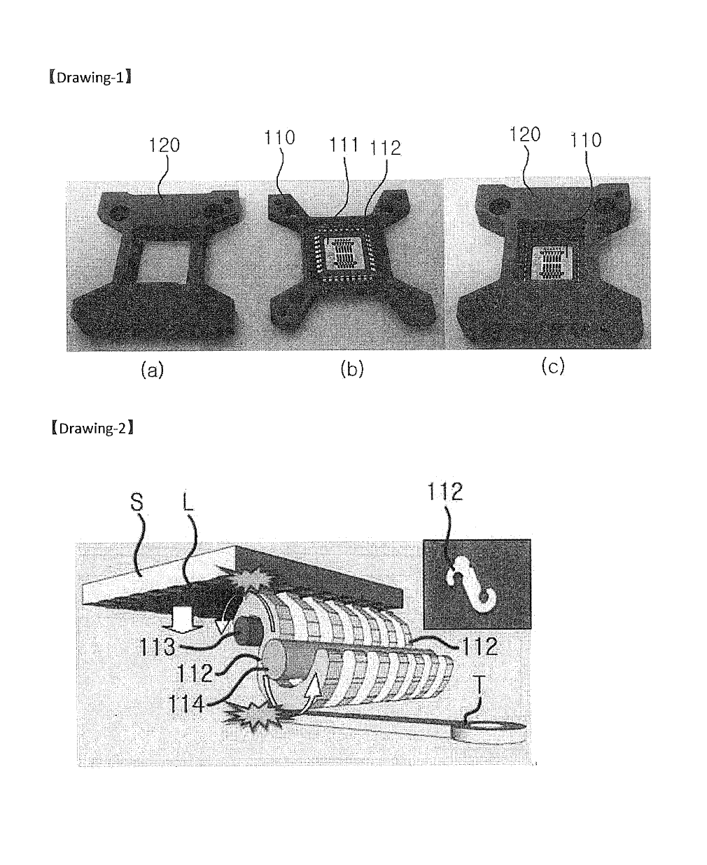

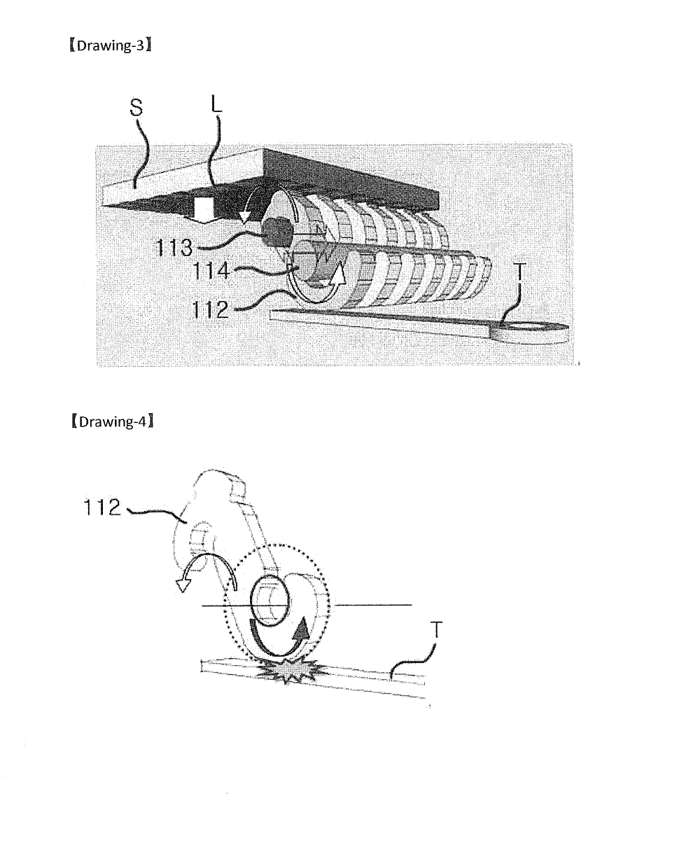

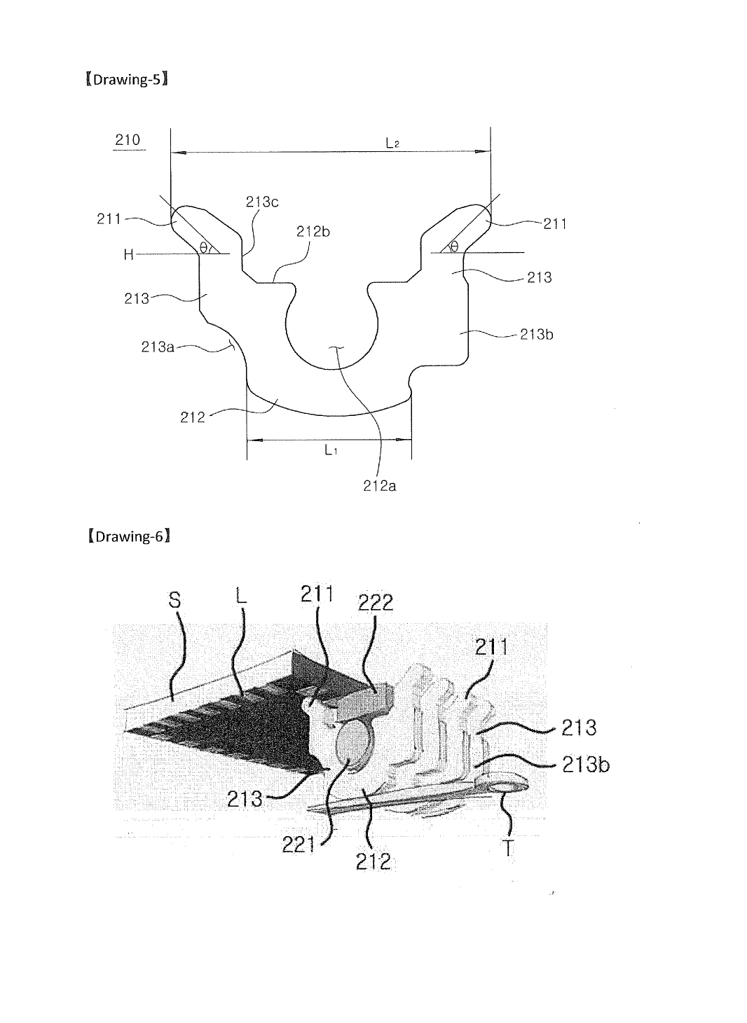

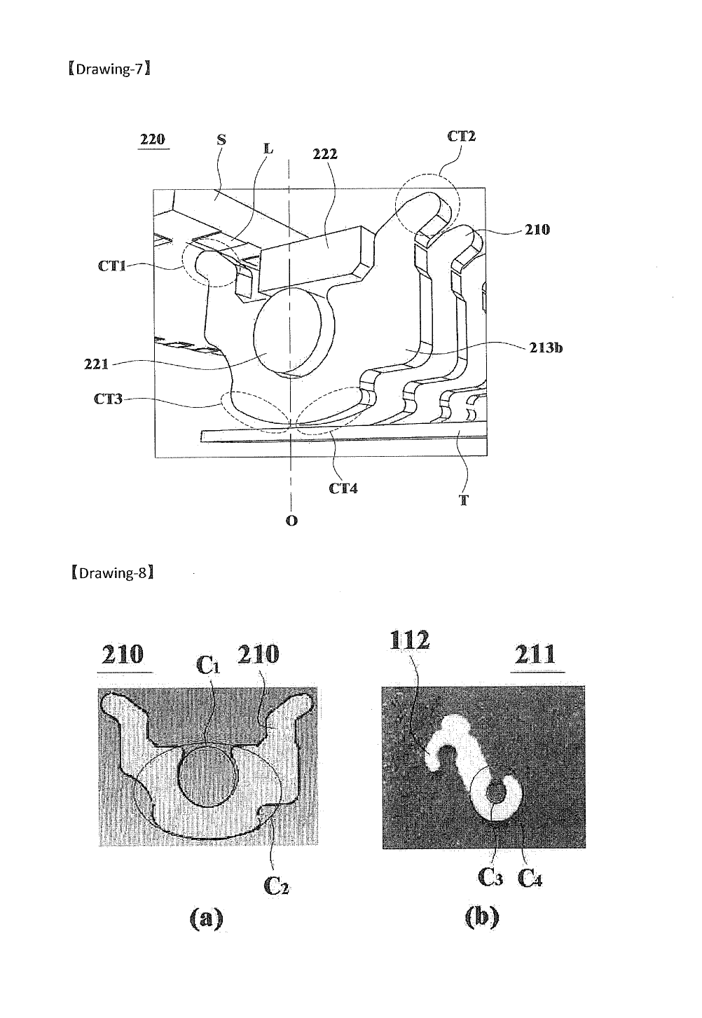

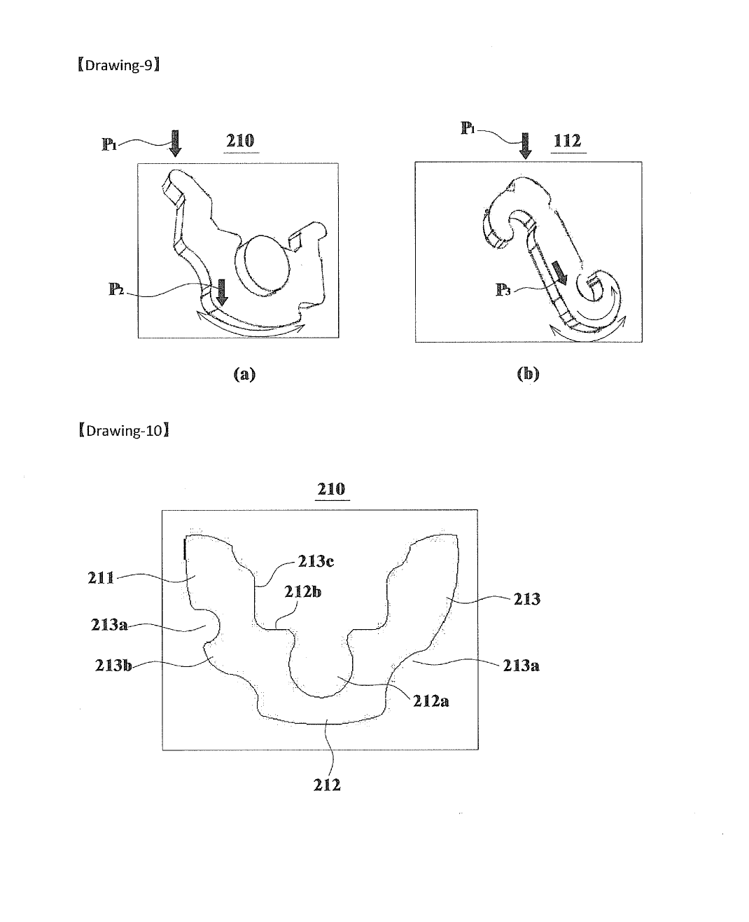

### PATENT SCOPE

This paper describes a new test socket pin design and its structure that has better performance in terms of contact quality, life time and overall maintenance cost. It has special features like pin rotation. This pin rotation feature can make user save the cost of manufacturing by using the same pin twice.

### BACKGROUND OF THE INVENTION

Now a day, there are significant trends being observed in semiconductor packaging and test area. Semiconductor chips are getting smaller while they are doing more things. More functions and smaller but there are more IO ports. It is possible because there are more chips integrated on a chip. So final test process is getting difficult and important. Final test process is the final gate that chip makers check their chip's own functions (electrical parameters like power, voltage, current and speed) specified in their data sheet to guarantee their quality. To test semiconductor chips, we need some physical interface between tester and semiconductor chips. Test socket is one of parts that make connection between tester and each device or chip.

Drawing-1 shows a normal socket's structure. Users insert the target devices to the socket hole, (C) of Drawing-1 and run their test program. Then, few seconds later, the test program returns test result as pass or fail.

Drawing-2 shows the detailed movement of device in the socket. IO pads of device are being pushed by handler arm and making contact with socket pin (112).

As shown in Drawing-2, previous test pin shape is like “S” and it has two elastomers for tension.

Once chip is being pushed, upper tip side touches device pad area and bottom side touches PCB pad area which is connected to the tester.

However, with its own structure the pin's upper side(112 of Drawing-2) scrubs the device IO pad and same PCB area(T of Drawing-2) and worn out its gold plating. Around 300,000 insertions are normal life time of this pin structure. Once worn out its gold plating, there is performance drop (low yield) followed. Then, need to replace the pin with new one. Before, there are some efforts to increase pin life time with new plating technology or with a new material types but they didn't work well.

In addition, like Drawing-3 the test pin (112) is fixed by two elastomers (113,114). These two elastomers work as rotary shaft(axis of rotation) and give returning tension to the semiconductor chip when they have pressure from handler arm. Once pressure has gone after test, these two elastomers provide returning force to the pin and it goes back to original status.

There are chances of poor connection if two elastomers lose tension or have some damages. The test pin (112) may have improper position as insertions. Then, there is contact problem followed. As we have two axis of rotation by elastomers (113,114), the problem has become more serious.

Drawing-4 shows the test pin's detailed shape and its movement when pressured. Solid line marked with is the axis of rotation of pin and dotted line is contact circles of pin with PCB pad area. Both two circles they can make good tension for pin but this structure can have problem. Relatively small radius of the pin could have more force concentration on the chip's 10 pad and PCB pad terminal(T). It can accelerate the wear of gold plating of pin at top and bottom side. Once the pin lost gold plating, there is performance drop followed. Electrically and physically. One big problem is severe wear(or digging problem) of PCB pad terminal(T) due to pin structure. Since the customized load board is very expensive one, if damaged, there are more cost than saving. their big problem for customer is operation cost as the price of the pin is expensive too. Also down time for pin change can be a problem.

### SUMMARY OF THE INVENTION/DISCLOSURE

### Patent Challenges

This paper suggests the new design concept for test socket and its pin. It has better movement and contact performance and can last longer by as longer as twice. So we can save operation cost for test as we use the pin twice and we have fewer components.

### Patent Summary

To accomplish its design performance, the pin shall have special shape & features like below.
1. The pin on the left and right there are two contact terminals (211, Drawing-5). These two contact terminals are symmetrical relative to the center circle (212a, Drawing-5).
2. The pin has wider circumference (212, Drawing-5) on the bottom side not to have force concentration on the PCB contact pad.
3. The pin is not partially symmetrical as it has orientation point (213b, Drawing-5) on the lower right(left) side. This orientation point can be on left or right side.
4. The pin has center circle cutting as pivot shaft. This center circle cutting is working as axis of the pin rotation. On the upper area of center circle, there are flat and square cutting area for rectangle tension elastomers.
5. The Contact terminal's (211, Drawing-5) proper horizontal angle is around 30° to 45°.
6. The pin is using rectangle elastomers as tension material.
7. The pin is using round typed retaining bar as rotary shaft.

### Effectiveness of Invention

As described, according to the present invention, there is improvement on pin movement with different types of shape and materials. It makes better contact between chip and PCB pad. So it finally improves reliability of testing.

In addition, there is cost reduction as we use the pin twice. Once the first contact terminal, forward side of pin, is worn out, can rotate the pin to rear side and reuse the opposite terminal and the reduction in the number of parts.

### BRIEF DESCRIPTION OF THE DRAWINGS

Drawing-1; Normal test socket's structure

Drawing-2; Normal test socket's pin movement details#1

Drawing-3; Normal test socket's pin movement details#2

Drawing-4; Normal test socket's pin movement details#3

Drawing-5; Antler test socket pin drawing, Front View

Drawing-6; Antler test socket structure and its components

Drawing-7; Antler test socket pin movement

Drawing-8; Pin comparison between normal socket pin & antler socket pin

Drawing-9; Pin movement comparison

Drawing-10; Other Antler pin type.

### DETAILED DESCRIPTION OF THE PREFERRED EMBODIMENT

With reference drawings attached, the Antler semiconductor test socket and its pin are described in detail.

Here we offer the socket for semiconductor chip package as one type of example to explain, but not limited to the present invention to chip package only. Other types of systems or packages that have input and output ports as grid or ball can be applied if Antler socket can be used.

Also, we can use the Antler socket and its pin for all the IC types including discrete types like inductors, capacitors and resistors.

Like Drawing-5, Antler pin (210) has two contact terminals (211) that touches IO ports of device(or chip package), one wider contact terminal (212) for PCB pad of load board and two frames (213). So overall shape of pin looks like deer Antler.

Thus, as described with reference of Drawing 1, array plate (120) of the socket housing (110) is placed(assembled) on a load board PCB of tester and user inserts a semiconductor chips (S) to the socket housing. Then, give pressure to the chip to make physical contact between contact terminal and semiconductor chip IO ports. At this time, while having contact between pin and chip IO ports, the pin has movement like seesaw. Once contact made, tester is performing programmed specific tests such as electrical properties, and functional characteristics of the product.

More specifically, the first contact terminal (211) is heading outside with upper slope, toward the top, and is to be in contact with on a semiconductor chip (S) of the input and output terminals (L), and the second contact terminals (212) mainly consists of a pair of spaced apart from each other from side to side like a seesaw pivot (ex, fluctuations). Also, when one side of a pair of first contact terminal (211) is worn out, the other side of the contact terminals (211) can be reversed, so its life time is extended at least two times longer.

Here, the first contact terminal (211), respectively, horizontal angle (H) of about 30° to 45° (θ) is desirable. If angle of terminal (211) is less than the 30°, it is hard to get a good contact because normally contact pad size is small.

The second contact terminal (212) connects PCB trace terminal(T) and semiconductor chip(S)'s input and output ports (L). And through this connection, tester's test signal is being delivered to the semiconductor chip's input and output for test. This contact terminal (211) is placed in the center of pin and has wider circumference (circumference) in the form of bending.

Thus, the semiconductor chip(S) of the input and output terminals (L) is pressured(while meeting the test terminal), the curved second contact terminal (212) is moving like a seesaw. In this case, when one side of a pair of first contact terminal (211) is worn out, the other side of the contact terminals (211) can be reversed, so its life time is extended at least two times longer.

L2 shall be longer than L2 for better movement of pin.

Body frame (213) has no specific rule for design but as shown it connects device contact terminal (1^{st} contact terminal, 211) and PCB contact terminal(2^{nd} contact terminal, 212). There is a groove, inner bending shape (213a) that makes Antler pin rotation easier and for further purpose.

As described above, there is a center hole (212a) for pivot axis of pin rotation and on its upper parts, there is square cutting (212b) for rectangle elastomers.

The square cutting has flat floor (212b) and flat wall (213c). These two flat zones will make rectangle type elastomers sitting tight when assembled.

Retaining bar (221) and rectangle elastomers(222) are key parts for Antler socket. Retaining bar (221) is for axis of pin rotation and rectangle elastomers(221) is for pin's recovery tension.

In other words, when semiconductor chip presses pins(with external force from outside), the first contact terminal (211) of pins are moving forward having elastomers tension. At this moment, pin's pivot axis is PCB contact terminal (222) on the bottom. With tension from elastomers, pin has strong force concentrations to the lower side. That makes firm connection between pin and PCB trade pad (T). Once pressure gone(Once test has done), restoring force is being made by elastomers and pins go back to original position.

Specially, rectangle elastomers (222) are providing wider surface area to the pins and this wider area provide many advantages to the pins such as pin position accuracy and excellent restoring force. As we have more advantages, we don't need two round elastomers (113,114) like competitors.

Drawing-6 is showing that the semiconductor chip test pin (210), and other central pivot axis (221) and elastomers (222) as main components[or major parts] for Antler semiconductor socket (220). There will be other two main parts, array plate (120) and the socket housing (110) and few screw parts for full socket set.

The test pin (210) is installed in pin container like Drawing 1-(b). Different thing is Antler is using one rectangle elastomers. The first contact terminal (211) shall be located in upper side of pin container. And guide plate (120) will be located on the top and assembled. Through the hole of base plate device or chip will be inserted and have contact between device IO (L) and pin's first contact terminal (211).

Only the first contact terminal (211) and the second contact terminal (212) will be exposed and other parts will be located inside of pin container.

Drawing-7 is showing Antler pin and its pair components for full socket assembly (220). As can be seen, the pin is being located on the dotted center line (O).

Here, when the first contact terminal (CT1) is used, the other side CT2 is being idle as spare terminal. Once CT1 is worn-out, user can rotate pin base on the dotted center line (O) and CT2 side will be used.

There are two contact areas in the bottom side of the pin, CT3 and CT4. When CT1 is got pressed by chip, CT3 is touching load board pad terminal (T) while CT4 is not being used. Also CT4 will be used once CT3 is worn-out.

Regarding on Elastomers, previously there were two elastomers being used for pin movement like the Drawing-6. However, Antler socket uses one elastomer (221) for axis of pin rotation. Another rectangle type elastomer is for pin's fine positioning and some more functions. This rectangle elastomer provides wider surface area for pin. So this structure makes the Antler pin get higher & more accurate recovery tension values.

Retaining bar acts as a central axis of pin movement. Its main purpose is to provide accurate poisoning for pins. It is not providing recovery tension to pin but should not disturb pin action. Normally, Antler socket's retaining bar is made of engineering plastic or hardened silicon rubber. Here engineering plastics are special plastics that are being used in industrial area such as Polyamide-based (Nylon), Polycarbonate, Polyacetal and etc.

There are two pictures in Drawing-8, (A) is an Antler pin and (B) is a previous normal pin shape from competitors.

Antler pin's rotational movement trajectory is like C2 of (B). Antler pin's radius of curvature of the bottom side is like oval shape so it has longer travel range against competitors'. However, previously since the pin shape is like small & perfect circle, lower side of pin is like semicircle and it has shorter travel range.

This shorter travel range of pin can make load board life time shorter as its movement results in damages on the surface of load board contact terminal. However, Antler pin has longer life time of load board as it has longer travel range from wider bottom contact terminal design. Like Drawing-9 the first contact terminal (211) takes down force from semiconductor lead(S) and it goes to 2^{nd} contact terminal (212). Due to its Elliptical shape structure of bottom side, it has wider contact size and this wider contact makes less contact resistance and more current flowing possible through the pin. This is why Antler pin is good for high power application.

The basic structure of the Antler pin follows a symmetric structure. The contact terminals are symmetric from a certain point. However, there could be other pin shapes that can be rotated and two contact terminals are touching the same points.

Here the Antler pin is symmetrical to the center circle but to let users know its orientation, we make identification mark as “213b”. It can be on either side on the first contact terminal.

Antler pin has an identification mark on its surface. At this version, its identification mark is 213b. There are several other types of identifications, such as hole, engravings, bump and hump. All can be used for Antler pins.

Drawing-10 shows the other types of Antler pin that has same features. It has different shape but basically follows Antler pins' concepts and features. The first contact terminal (212), Body Frame(213), Identification (213b), Tension wall (213c), Elastomer pocket (212b). Each block's function is very similar to Drawing-5's. So skip each block's function.

The present invention has been described with respect to specific Antler Pins.

However, the scope of the invention is not to be limited to this particular Antler pin shapes. Key items for the invention will be pin rotation to use our pin twice.

Not changing the nature of the present invention within the scope that modifications and variations are possible in the area if a person understands.

Thus, in the above-described embodiments of the invention are of ordinary skill in the art to a person to completely notify the scope of the invention because it is provided for, in all respects as illustrative and non-limiting understanding only, and the invention will only be defined by the appended claims.

### PIN BLOCK NUMBER DESCRIPTION

211: First contact terminal
212: Second contact terminal
212a: Center Hole, 212b: Elastomer Pocket
213: Body Frame, 213a: Tension Slide
213b: Identification Point, 213c: Tension Wall
221: Retaining Bar
222: Rectangle Elastomer
S: Semiconductor Chip
L: Semiconductor Lead
T: Tester Terminal

1. The pin shall have these key features below
two contact terminals on its upper side (211);
one wider contact terminal(212) on the bottom side
two body Frames(213) that has contact slide (213a) and identification point (213b)
center hole (212a) for pivot shaft (Retaining bar)
tension Wall (213C) and Elastomer Pocket (212b) for tension elastomer.

2. As in claim 1, the pin's 1^{st} contact terminal (211) shall have horizontal angle size from 30° to 45°.

3. As in claim 1, the pin shall has central pivot axis shaft (221) to make pin's accurate movement, the 2^{nd} contact terminal will be fixed on the lower side and it provides movement radius, the 1^{st} contact terminal will move to left or right with pressure force from the top based on central pivot shaft.

4. As in claim 1, the 2^{nd} Contact terminal's Radius of curvature is always larger than the size of center hole diameter and its shape is like inverted oval, its movement is being made upon its extensional elliptic trace line.

5. As in claim 1, the pin shall use rectangle elastomers for pin's recovery tension it is being sited on Elastomer pocket (212b), recovery tension is made by tension wall (213c) once pressed.

6. As in claim 1, the pin has tension slide (213a) to make better pin movement.

7. As in claim 1, the pin has two contact terminals which are symmetrical relative to center hole and one of two contact terminals will have an identification point.

8. As in claim 1, the pin shall have two contact terminals and these two contact terminals are located symmetrically only, their outer-line shape can be different, the key point is each terminal's symmetrical coordinates.

9. The socket will use the Antler pin's full features from claim 1, the socket will use Antler pin, rectangle elastomers, pivot shaft.

10. The socket's pivot shaft (Retaining Bar) is made of engineering plastic or hardened rubber.

11. The pin's recovery tension is being made by rectangle typed silicon elastomers.
